(19) United States
(12) Patent Application Publication
(10) Pub. No.: US 2016/0171276 A1
(43) Pub. Date: Jun. 16, 2016

(54) Fingerprint Sensor Having ESD Protection Structure

(71) Applicant: ELAN MICROELECTRONICS CORPORATION, Hsinchu (TW)

(72) Inventors: Tsung-Yin Chiang, Xingang Township (TW); Chun-Chi Wang, Puli Township (TW); Chung-An Tang, Zhubei City (TW)

(73) Assignee: ELAN MICROELECTRONICS CORPORATION, Hsinchu (TW)

(21) Appl. No.: 14/940,016

(22) Filed: Nov. 12, 2015

Related U.S. Application Data
(60) Provisional application No. 62/090,364, filed on Dec. 11, 2014.

(30) Foreign Application Priority Data
Feb. 26, 2015 (TW) 104106180

(51) Int. Cl. G06K 9/00

(52) U.S. Cl. CPC G06K 9/00053; G06K 9/0002

(57) ABSTRACT

A fingerprint sensor having ESD protection structure and has a substrate having an upper surface. Multiple sensing electrode plates, an ESD protection electrode part connected to ground, a dielectric layer and a protection layer are formed on the upper surface in bottom-up sequence. The ESD protection layer has a first conductive layer and a second conductive layer. The first conductive layer is formed on the upper surface and coplanar with the sensing electrode plates. The second conductive layer is formed on the dielectric layer and has multiple separated conductive elements. Each of conductive elements overlaps the first conductive layer along a vertical axis and connected to the first conductive layer via multiple vias formed in the dielectric layer. When the first conductive layer and/or the second conductive layer are/is coupled to ground, both of the first and second conductive layers are established a discharging path of static electricity.

### CROSS-REFERENCE TO RELATED APPLICATIONS

This application claims the benefit of United States provisional application filed on Dec. 11, 2014 and having application Ser. No. 62/090,364, the entire contents of which are hereby incorporated herein by reference

This application is based upon and claims priority under 35 U.S.C. 119 from Taiwan Patent Application No. 104106180 filed on Feb. 26, 2015, which is hereby specifically incorporated herein by this reference thereto.

### BACKGROUND OF THE INVENTION

1. Field of the Invention

The present invention relates to a fingerprint sensor, especially to a fingerprint sensor having ESD protection structure.

2. Description of the Prior Arts

With reference to FIGS. 9 and 10, a fingerprint sensing chip as disclosed by U.S. Pat. No. 5,325,442 has a semiconductor substrate 80, a sensing electrode layer 60 formed on a top of the semiconductor substrate 80, a protection layer 81 covering the sensing electrode layer 60 and a sensing integrated circuit formed in the semiconductor substrate 80 and electrically connected to the sensing electrode layer 60. The sensing electrode layer 60 has multiple sensing electrode plates 61 arranged in a matrix. When a finger 90 approaches or touches the protection layer 81, a capacitor Cf is formed between the finger 90 and each of the sensing electrode plates 61 corresponding to the finger 90. The sensing integrated circuit senses a sensing signal from each of the sensing electrode plates 61 corresponding to the finger 90. The sensing integrated circuit further determines that each sensing electrode plate 61 corresponds to a ridge or a valley of the finger's fingerprint according to the sensed sensing signal thereof. Therefore, the fingerprint sensing chip reads an image of the finger's fingerprint.

Since the finger 90 approaches or touches the fingerprint sensing chip along with static electricity, the static electricity damages the semiconductor elements of the fingerprint sensing chip, such as the semiconductor elements of the sensing electrode plates 61 and the sensing integrated circuit. To prevent static electricity damage, the sensing electrode layer 60 further has a conductive grid 70. The conductive grid 70 and the sensing electrode plates 61 are coplanar. The conductive grid 70 is connected to ground to provide a discharging path for the static electricity. The static electricity is discharged to ground through the conductive grid 70 when the finger 90 approaches or touches the protection layer 81.

Since the conductive grid 70 and the sensing electrode plates 61 are coplanar, a distance between the finger 90 and the conductive grid 70 is substantially close to a distance between the finger 90 and the sensing electrode plates 61. If the static electricity has a larger energy and the static electricity can not be immediately discharged by the conductive grid 70, the sensing electrode plates 61 may be damaged, accordingly. The accuracy of identifying fingerprint image of the fingerprint sensing chip is decreased.

To overcome the shortcomings, the present invention provides a fingerprint sensor having ESD protection structure to mitigate or obviate the aforementioned problems.

### SUMMARY OF THE INVENTION

Based on the aforementioned drawbacks of the conventional fingerprint sensing chip, an objective of the present invention provides a fingerprint sensor having a good ESD protection efficacy.

To achieve the aforementioned objective, the present invention provides the fingerprint sensor having ESD protection structure having:

multiple sensing electrode plates formed on a substrate and defining a receiving space among the sensing electrode plates;

an ESD protection electrode part connected to ground and having a first conductive layer and a second conductive layer, wherein the first conductive layer is formed on the substrate and coplanar with the sensing electrode plates, and the first conductive layer is positioned in the receiving space, and the second conductive layer has multiple conductive elements separated to each other;

a dielectric layer formed on the substrate and covering the sensing electrode plates and the first conductive layer, the second conductive layer formed on the dielectric layer and the conductive elements overlapping the first conductive layer on a vertical axis, wherein the dielectric layer having multiple vias comprising a conductive material therein to electrically connect to the first conductive layer; and

a protection layer formed on the dielectric layer to cover the second conductive layer.

Based on the foregoing description, the ESD protection substrate of the present invention mainly has the first and second conductive layers and the second conductive layer is higher than the first conductive layer. Both of them commonly provide a charging path for static electricity, since one of them is connected to ground and the other is electrically connected to ground through the vias. When a finger approaches or touches the fingerprint sensor, the static electricity from the finger is firstly discharged to ground through the second conductive layer and then discharged to ground through the first conductive layer if the static electricity has a larger energy. Therefore, the sensing electrode plates prevent the static electricity damage.

Other objectives, advantages and novel features of the invention will become more apparent from the following detailed description when taken in conjunction with the accompanying drawings.

### BRIEF DESCRIPTION OF THE DRAWINGS

FIG. 1 is a top plan view of a first embodiment of a fingerprint sensor in accordance with the present invention;

FIG. 2 is a top plan view of a partial structure of FIG. 1;

FIG. 3 is an enlarged top plan view of a portion of FIG. 1;

FIGS. 4A to 4C are cross sectional views taken along A-A, B-B and C-C lines of FIG. 3;

FIG. 5 is a top plan view of a second embodiment of a fingerprint sensor in accordance with the present invention;

FIG. 6 is a top plan view of a third embodiment of a fingerprint sensor in accordance with the present invention;

FIG. 7 is a top plan view of a fourth embodiment of a fingerprint sensor in accordance with the present invention;

FIG. 8 is a top plan view of a fifth embodiment of a fingerprint sensor in accordance with the present invention;

FIG. 9 is a top plan view of a portion of a fingerprint sensing chip disclosed by U.S. Pat. No. 5,325,442; and

FIG. 10 is a cross sectional view of partial structure of FIG. 9.

### DETAILED DESCRIPTION OF THE EMBODIMENTS

The present invention provides an ESD protection structure for a fingerprint sensor to prevent static electricity damage. Many embodiments of the present invention are used to describe a detailed structure of the fingerprint sensor in accordance with the present invention.

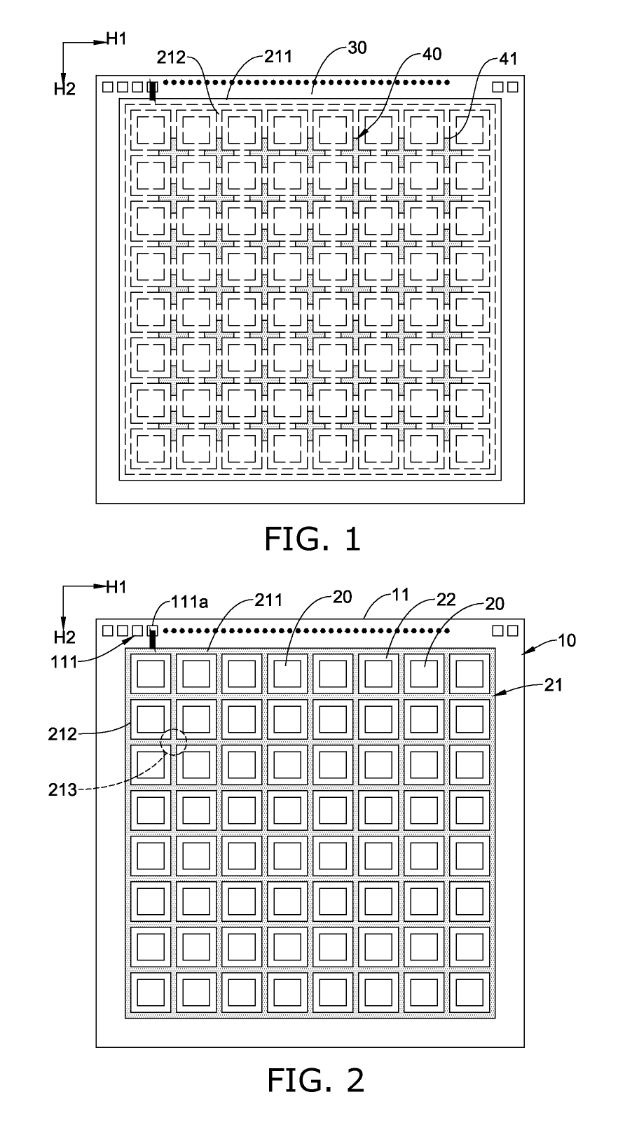

With reference to FIGS. 1, 2 and 4A, a first embodiment of the fingerprint sensor 10 of the present invention has a substrate 11, multiple sensing electrode plates 20, an ESD protection electrode part, a dielectric layer 30 and a protection layer 50. The ESD protection electrode part is connected to ground and has a first conductive layer 21 and a second conductive layer 40.

The multiple sensing electrode plates 20 are respectively formed on an upper surface of the substrate 11. A receiving space 22 is defined among the sensing electrode plates 20. In the first embodiment, each of the sensing electrode plate 20 is square and is formed on the upper surface of the substrate 11 in a matrix and the receiving space 22 is formed as a shape of a grid. The substrate 11 may be a semiconductor substrate. The sensing electrode plates 20 are connected to a sensing circuit. A sensing signal of the sensing electrode plate 20 is used to determine that the sensing electrode plate 20 corresponds to a ridge or a valley of a finger's fingerprint when the finger approaches or touches the fingerprint sensor 10. The fingerprint sensor 10 obtains an image of the fingerprint.

With further reference to FIG. 4B, the first conductive layer 21 is formed on the upper surface of the substrate 11 and is positioned in the receiving space 22, and is coplanar with the sensing electrode plates 20. The first conductive layer 21 is connected to ground to provide a discharging path for the static electricity. The ground may be earth ground or a constant voltage. In the first embodiment, the first conductive layer 21 is formed as a shape of the grid and the receiving space 22 is also formed as a shape of the grid. The first conductive layer 21 is positioned in the receiving space 22. There is a gap between the first conductive layer 21 and the sensing electrode plates 20 to separate the first conductive layer 21 and the sensing electrode plates 20. The grid-shaped first conductive layer 21 has multiple first conductive parts 211 formed on the upper surface of the substrate 11 along a first horizontal axis H1, and multiple second conductive parts 212 formed on the upper surface of the substrate 11 along a second horizontal axis H2.

The dielectric layer 30 is formed on the upper surface of the substrate 11 and covers the sensing electrode plates 20 and the first conductive layer 21. The dielectric layer 30 has multiple vias 31 corresponding to the first conductive layer 21. With further reference to FIGS. 4A and 4C, each via 31 has a conductive material therein to electrically connect between the first and second conductive layers 21, 40. In the first embodiment, the vias 31 correspond to and are connected to each intersection 213 of the first and second conductive parts 211, 212.

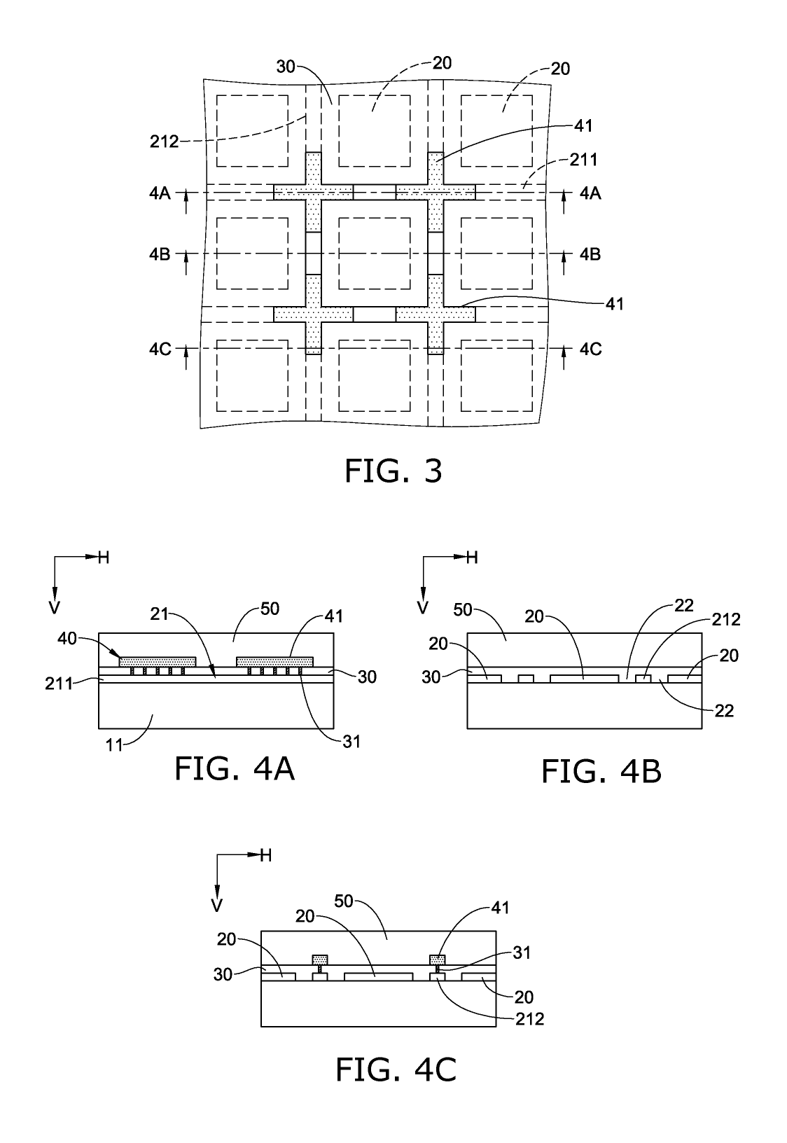

The second conductive layer 40 is formed on an upper surface of the dielectric layer 30 and has multiple conductive elements 41. Each conductive element 41 overlaps the first conductive layer 21 along a vertical axis V. With reference to FIG. 4A, a gap is defined between the two adjacent conductive elements 41, so the conductive elements 41 are separated to each other. In the first embodiment, each conductive element 41 is formed as a shape of a cross and overlaps the corresponding intersection 213 of the first and second conductive parts 211, 212 along the vertical axis V. Each cross-shaped conductive element 41 is electrically connected to the corresponding intersection 213 of the first and second conductive parts 211, 212 through the via 31 as shown in FIGS. 3, 4A to 4C. To prevent the sensing signals of the sensing electrode plates 20 from being sheltered by the second conductive layer 40 connected to ground, each conductive element 41 does not overlap the sensing electrode plates 20 thereof. That is, a width and a length of the conductive element 41 are equal to or smaller than those of the receiving space 22.

The protection layer 50 is formed on an upper surface of the dielectric layer 30 and covers the second conductive layer 40 to protect the second conductive layer 40, as shown in FIGS. 4A and 4C.

Based on the foregoing description, the first conductive layer 21 is coplanar with the sensing electrode plates 20, the second conductive layer 40 is formed on the dielectric layer 30, which covers the first conductive layer 21 and the sensing electrode plates 20. The second conductive layer 40 is higher than the first conductive layer 21. The second conductive layer 40 overlaps the first conductive layer 21 along the vertical axis V and the second conductive layer 40 is electrically connected to the first conductive layer 21. When one of the first and second conductive layers 21, 40 is connected to ground, the first and second conductive layers 21, 40 commonly provide a discharging path. In the first embodiment, the first conductive layer 21 is directly connected to ground, so the second conductive layer 40 is electrically connected to ground through the first conductive layer 21. In other embodiments, the conductive element 41 of the second conductive layer 40 is directly connected to ground so the first conductive layer 21 is connected to ground through the second conductive layer 40. When a finger with the static electricity approaches or touches the fingerprint sensor 10, a first distance between the second conductive layer 40 and the finger is shorter than a second distance between the first conductive layer 21 and the finger. Thus, the static electricity is discharged to ground through the second conductive layer 40 in advance. Therefore, the static electricity does not damage other elements.

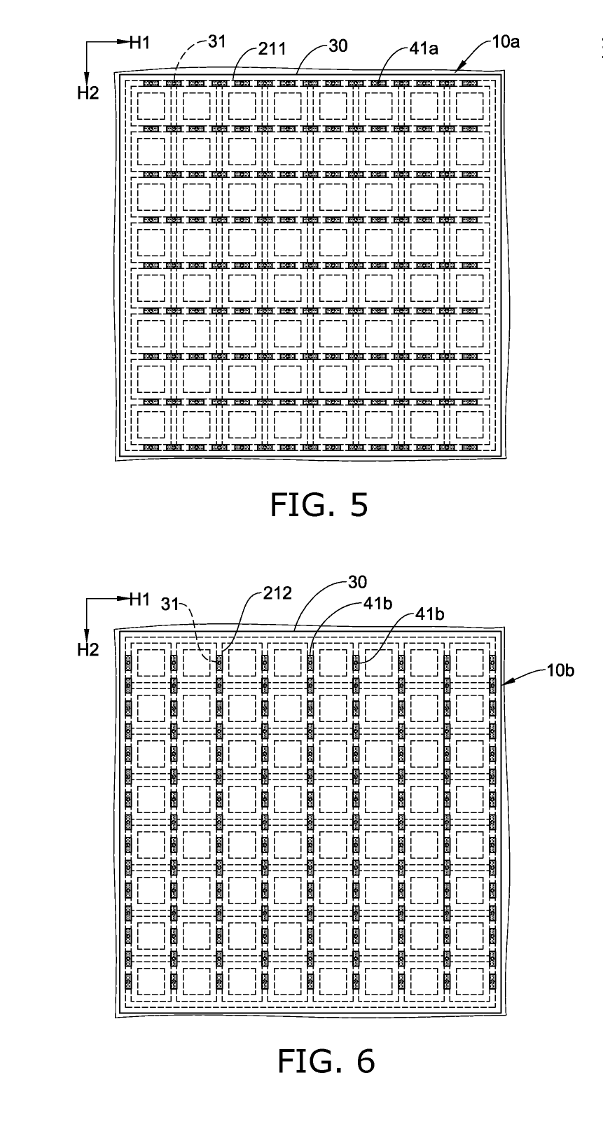

With reference to FIG. 5, a fingerprint sensor 10a of the second embodiment of the present invention is similar to the fingerprint sensor 10 of the first embodiment as shown in FIG. 2, but multiple vias 31 are formed in the dielectric layer 30 and correspond to the first conductive parts 211 of the first conductive layer 21. Each conductive element 41a is formed as a shape of bar and the conductive elements 41a are respectively and separately formed on the dielectric layer 30 along the first horizontal axis H1. The gap is defined between the two adjacent conductive elements 41a. Each conductive element 41a is connected to the corresponding first conductive part 211 through the via 31.

With reference to FIG. 6, a fingerprint sensor 10b of the third embodiment of the present invention is similar to the fingerprint sensor 10 of the first embodiment as shown in FIG. 2, but multiple vias 31 are formed in the dielectric layer 30 and correspond to the second conductive parts 212 of the first conductive layer 21. Each conductive element 41b is formed as a shape of bar and the conductive elements 41b are respectively and separately formed on the dielectric layer 30 along the second horizontal axis H2. A gap is defined between the two adjacent conductive elements 41b. Each conductive element 41b is connected to the corresponding second conductive part 212 through the via 31.

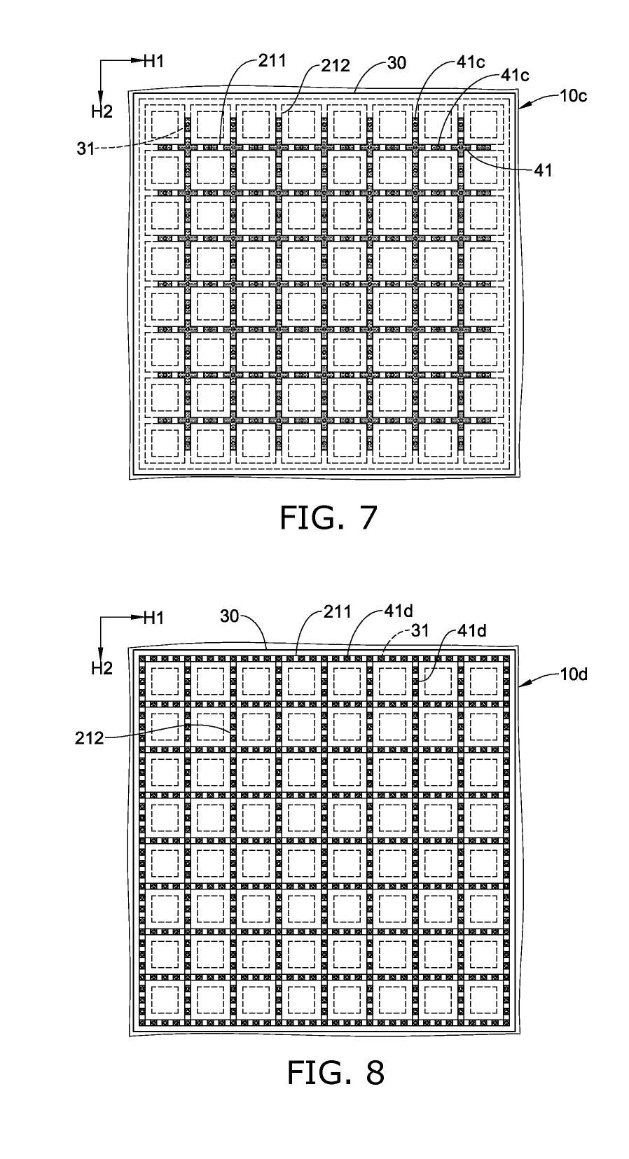

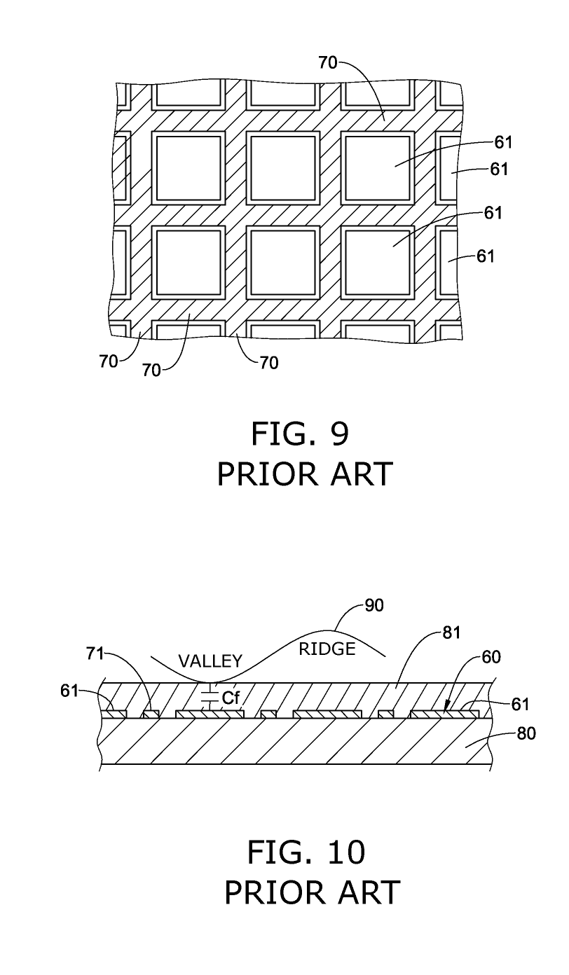

With reference to FIG. 7, a fingerprint sensor 10c of the fourth embodiment of the present invention is similar to the fingerprint sensor 10 of the first embodiment as shown in FIG. 2. in the fourth embodiment, the multiple vias 31 are not only formed in the dielectric layer 30 and correspond to each intersection 213 of the first and second conductive parts 211, 212, but also formed in the dielectric layer 30 along the first and second conductive parts 211, 212 of the first conductive layer 21. Therefore, the second conductive layer 40 has multiple cross-shaped conductive elements 41 and multiple bar-shaped conductive elements 41c. The conductive elements 41c are respectively and separately formed on the dielectric layer 30 along the first and second horizontal axes H1, H2. Each bar-shaped conductive element 41c is located between the two adjacent cross-shaped conductive elements 41. A gap is defined between the bar-shaped conductive element 41c and the cross-shaped conductive elements 41. Each conductive element 41c is connected to the corresponding first and second conductive part 211, 212 through the via 31. With reference to FIG. 8, a fingerprint sensor 10d of the fifth embodiment of the present invention is similar to the fingerprint sensor 10 of the first embodiment as shown in FIG. 2, but multiple vias 31 are formed in the dielectric layer 30 and correspond to the first and second conductive parts 211, 212 of the first conductive layer 21. The second conductive layer 40 has multiple block-shaped conductive elements 41d. The conductive elements 41d are respectively and separately formed on the dielectric layer 30 along the first and second horizontal axes H1, H2. A gap is defined between the two adjacent conductive elements 41d. Each conductive element 41d is connected to the corresponding first and second conductive part 211, 212 through the via 31. Based on the foregoing description, the first and/or second conductive layers 21, 40 are used to be connected to ground to establish an ESD protection structure. With reference to FIG. 2, the first or second conductive layers 21, 40 may be wired to a ground pad 111a of multiple I/O pads 111 formed around the substrate 11 and the ground pad 111a is connected to an external ground signal. If the first conductive layer 21 is wired to the ground pad 111a, each of the conductive elements 41 of the second conductive layer 40 is connected to the first conductive layer 21 through the via 31. Therefore, the first and second conductive layers 21, 40 can commonly provide the discharging path of the static electricity even if the second conductive layer 40 is not wired to the ground pad 111a of the substrate 11. In the same way, when the second conductive layer 40 is wired to the ground pad 111a and the first conductive layer 21 is not wired to the ground pad 111a of the substrate 11, the first and second conductive layers 21, 40 can also commonly provide the discharging path of the static electricity. In addition, both of the first and second conductive layers 21, 40 may be wired to the ground pads 111a. Since the second conductive layer 40 is higher than the sensing electrode plates 20 and the first conductive layer 21, the static electricity from the finger firstly is discharged to ground through the second conductive layer 40 when the finger with static electricity approaches or touches the fingerprint sensor. Therefore, the sensing electrode plates 20 prevent the static electricity damage.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A fingerprint sensor having ESD protection structure, comprising:
multiple sensing electrode plates formed on a substrate and defining a receiving space among the sensing electrode plates;
an ESD protection electrode part connected to ground and having:
a first conductive layer formed on the substrate and being coplanar with the sensing electrode plates, and the first conductive layer positioned in the receiving space; and
a second conductive layer having multiple conductive elements separated to each other;
a dielectric layer formed on the substrate and covering the sensing electrode plates and the first conductive layer, the second conductive layer formed on the dielectric layer and the conductive elements overlapping the first conductive layer on a vertical axis, wherein the dielectric layer having multiple vias comprising a conductive material therein to electrically connect to the first conductive layer; and
a protection layer formed on the dielectric layer to cover the second conductive layer.

2. The fingerprint sensor as claimed in claim 1, wherein
the sensing electrode plates are arranged on the substrate in a matrix;
the receiving space is formed as a shape of grid; and
the first conductive layer is formed as a shape of grid and has:
multiple first conductive parts formed along a first horizontal axis; and
multiple second conductive parts formed along a second horizontal axis.

3. The fingerprint sensor as claimed in claim 2, wherein the conductive elements are separately formed in the receiving space along the first horizontal axis, each conductive element of the second conductive layer is formed as a shape of bar and is connected to the corresponding first conductive part through the via.

4. The fingerprint sensor as claimed in claim 2, wherein the conductive elements are separately formed in the receiving space along the second horizontal axis, each conductive element of the second conductive layer is formed as a shape of bar and is connected to the corresponding second conductive part through the via.

5. The fingerprint sensor as claimed in claim 2, wherein the conductive elements are separately formed in the receiving space along the first and second horizontal axes, each conductive element of the second conductive layer is formed as a shape of bar and is connected to the corresponding first or second conductive part through the via.

6. The fingerprint sensor as claimed in claim 2, wherein each conductive element corresponding to an intersection of the first and second conductive parts is formed as a shape of cross and is connected to the first conductive layer through the via.

7. The fingerprint sensor as claimed in claim 5, wherein each conductive element corresponding to an intersection of the first and second conductive parts is formed as a shape of cross and is connected to the first conductive layer through the via.

8. The fingerprint sensor as claimed in claim 1, wherein the first conductive layer is connected to ground.

9. The fingerprint sensor as claimed in claim 1, wherein the second conductive layer is connected to ground.

10. The fingerprint sensor as claimed in claim 8, wherein the second conductive layer is connected to ground.

11. The fingerprint sensor as claimed in claim 1, wherein the substrate is a semiconductor substrate to form a sensing circuit, and the sensing circuit is adapted to drive each sensing electrode plate and to receive capacitance variation from each sensing electrode plate.
